(19) United States
(12) Patent Application Publication
(10) Pub. No.: US 2026/0331681 A1
(43) Pub. Date: Oct. 22, 2026

(54) BATTERY PACK

(71) Applicant: TOYOTA JIDOSHA KABUSHIKI KAISHA, Toyota-shi (JP)

(72) Inventors: Osamu YAMASHITA, Toyota-shi (JP); Takuya ARAKAWA, Nagakute-shi (JP); Makoto IWATA, Toyota-shi (JP); Kenta KIMURA, Nagoya-shi (JP); Ryo KIMURA, Nagoya-shi (JP); Kunihiro TSUNEKAWA, Toyota-shi (JP); Koichi YANASE, Nagoya-shi (JP)

(73) Assignee: TOYOTA JIDOSHA KABUSHIKI KAISHA, Toyota-shi (JP)

(21) Appl. No.: 19/537,805

(22) Filed: Feb. 12, 2026

(30) Foreign Application Priority Data
Apr. 17, 2025 (JP) 2025-068263

(51) Int. Cl. H01M 50/264; H01M 50/204

(52) U.S. Cl. CPC H01M 50/264; H01M 50/204

(57) ABSTRACT

The battery pack may include a plurality of battery modules, a casing that houses the battery modules, and a plurality of bolts that fixes the battery modules to the casing. The battery modules may be arranged in a matrix along a first direction and a second direction. Each of the battery modules may have a rectangular shape having four corners, as viewed in plan along a third direction perpendicular to the first direction and the second direction. A first fixing portion, a second fixing portion, a third fixing portion, and a fourth fixing portion that are located at different heights may be provided at the four corners, respectively. In four battery modules with the corners located adjacent to each other among the battery modules, the first, second, third, and fourth fixing portions may be stacked on one another and may be fastened together to the casing by a common bolt.

### CROSS-REFERENCE TO RELATED APPLICATION

This application claims priority to Japanese Patent Application No. 2025-068263 filed on Apr. 17, 2025. The disclosure of the above-identified application, including the specification, drawings, and claims, is incorporated by reference herein in its entirety.

### BACKGROUND

### 1. Technical Field

The technology disclosed in the present specification relates to battery packs.

### 2. Description of Related Art

US Unexamined Patent Application Publication No. 2017/0365887 describes a battery pack for use in an electrified vehicle. This battery pack includes a plurality of battery modules arranged in a matrix, a casing that houses the battery modules, and a plurality of fastening members that fixes the battery modules to the casing.

### SUMMARY

Each of the battery modules is provided with multiple fastening members. Each battery module is fixed to the casing using the fastening members. In this case, however, the number of components of the battery pack is large, and the assembly process of the battery pack becomes complicated. This specification provides a technology that reduces the number of components of the battery pack and, in this respect, simplifies the assembly process.

The technology disclosed in this specification is embodied in a battery pack. The battery pack may include a plurality of battery modules, a casing that houses the battery modules, and a plurality of bolts that fixes the battery modules to the casing. The battery modules may be arranged in a matrix along a first direction and a second direction. Each of the battery modules may have a rectangular shape having four corners, as viewed in plan along a third direction perpendicular to the first direction and the second direction. A first fixing portion, a second fixing portion, a third fixing portion, and a fourth fixing portion that are located at different heights may be provided at the four corners, respectively. In four battery modules with the corners located adjacent to each other among the battery modules, the first, second, third, and fourth fixing portions may be stacked on one another and may be fastened together to the casing by a common bolt.

In the above configuration, among the fixing portions of the battery modules, four fixing portions that are stacked on one another are fastened together to the casing by a common bolt. This configuration makes it possible to reduce the number of bolts used for fastening the battery modules to the casing. As a result, the number of operations for fastening the bolts is also reduced, thereby simplifying the assembly process of the battery pack.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view showing a battery pack;

FIG. 2A is a plan view of a battery module, showing the configuration of the battery module;

FIG. 2B is a side view of the battery module, showing the configuration of the battery module;

FIG. 3A is a sectional view taken along line IIIa-IIIa in FIG. 1;

FIG. 3B is a sectional view taken along line IIIb-IIIb in FIG. 1;

FIG. 3C is a sectional view taken along line IIIc-IIIc in FIG. 1;

FIG. 4A is a sectional view taken along line IVa-IVa in FIG. 1; and

FIG. 4B is a sectional view taken along line IVb-IVb in FIG. 1.

### DETAILED DESCRIPTION OF EMBODIMENTS

In one embodiment of the present technology, at one side of an outer peripheral edge of the battery modules, one of the first, second, third, and fourth fixing portions of one battery module and one of the first, second, third, and fourth fixing portions of another battery module may be stacked on one another and may be fastened together to the casing by a common bolt. With such a configuration, the assembly process of the battery pack is further simplified.

In one embodiment of the present disclosure, at one side of the outer peripheral edge of the battery modules, one of the first, second, third, and fourth fixing portions of one battery module and one of the first, second, third, and fourth fixing portions of another battery module may be stacked on one another via a spacer and may be fastened together to the casing by a common bolt. With such a configuration, even at the outer peripheral edge where not all of the four fastening portions are stacked on one another, the battery modules can be stably fixed to the casing.

In one embodiment of the present disclosure, at one side of the outer peripheral edge of the battery modules, the first fixing portion of one battery module and one of the second, third, and fourth fixing portions of another battery module may be stacked on one another and may be fastened together to a first region of the casing by a common bolt. At another side of the outer peripheral edge of the battery modules, either the second fixing portion or the third fixing portion of one battery module and either the third fixing portion or the fourth fixing portion of another battery module may be stacked on one another and may be fastened together to a second region of the casing by a common bolt. In this case, the height position of the first region of the casing may be different from the height position of the second region of the casing. With such a configuration, even at the outer peripheral edge where not all of the four fastening portions are stacked on one another, the battery modules can be stably fixed to the casing.

In the above embodiment, the height position of the first fixing portion may be lower than the height position of the second fixing portion, the height position of the second fixing portion may be lower than the height position of the third fixing portion, and the height position of the third fixing portion may be lower than the height position of the fourth fixing portion. With such a configuration, the configuration of the present technology can be actively adopted.

The battery pack 10 according to an embodiment will be described with reference to the drawings. The battery pack 10 of the present embodiment can be mounted, for example, on a vehicle. The vehicle is, for example, a battery electric vehicle (BEV). However, the vehicle is not limited to a BEV, and may be another type of electrified vehicle such as a hybrid electric vehicle (HEV) or a plug-in hybrid electric vehicle (PHEV). The battery pack 10 can supply electric power to a motor that drives the wheels of the vehicle.

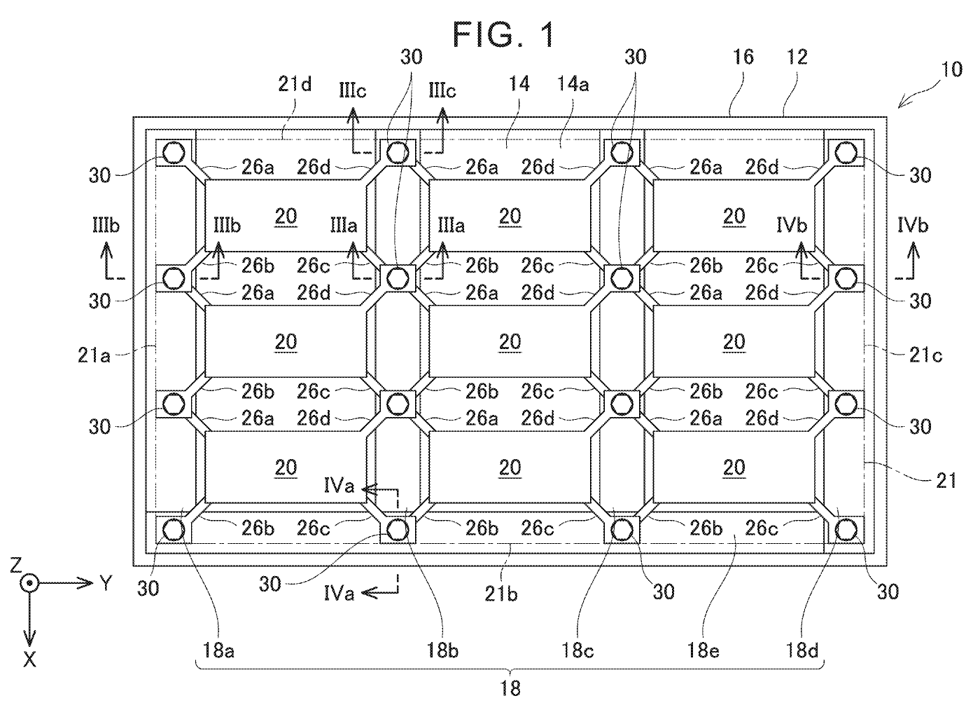

As shown in FIG. 1, the battery pack 10 includes a plurality of battery modules 20, a casing 12, a plurality of bolts 30 that fixes the battery modules 20 to the casing 12, and a plurality of spacers 28. The battery modules 20 are housed inside the casing 12. The battery modules 20 are each fixed to the casing 12 using the bolts 30.

The casing 12 is a box-shaped member having a bottom, and has a bottom wall 14 and a peripheral wall 16. The bottom wall 14 is a substantially rectangular flat plate member. As one example, an upper surface 14a of the bottom wall 14 has a substantially rectangular shape. The peripheral wall 16 extends upward from an outer peripheral edge of the upper surface 14a of the bottom wall 14. On the upper surface 14a of the bottom wall 14, the battery modules 20 are arranged in a matrix along the longitudinal direction of the upper surface 14a of the bottom wall 14 and a width direction perpendicular to the longitudinal direction.

In the drawings, the longitudinal direction of the upper surface 14a of the bottom wall 14 of the battery pack 10 is indicated by the Y-axis, one side in the longitudinal direction is indicated by the negative direction of the Y-axis, and the other side in the longitudinal direction is indicated by the positive direction of the Y-axis. On the upper surface 14a of the bottom wall 14 of the battery pack 10, the width direction of the battery pack 10 perpendicular to the longitudinal direction is indicated by the X-axis, one side in the width direction is indicated by the negative direction of the X-axis, and the other side in the width direction is indicated by the positive direction of the X-axis. The up-down direction of the battery pack 10 perpendicular to the upper surface 14a (i.e., the XY-plane) of the bottom wall 14 of the battery pack 10 is indicated by the Z-axis, the upper side in the up-down direction is indicated by the positive direction of the Z-axis, and the lower side in the up-down direction (i.e., also referred to as the plan-view direction of the battery pack 10) is indicated by the negative direction of the Z-axis.

The casing 12 has a plurality of beams 18 fixed to the upper surface 14a of the bottom wall 14. The beams 18 are structural members of the casing 12. The beams 18 extend along the upper surface 14a of the bottom wall 14. Each beam 18 has, for example, a tubular or hat-shaped cross section. The cross section as used herein refers to a section obtained by cutting along a plane perpendicular to the longitudinal direction of the beam 18. The beams 18 include beams 18a, 18b, 18c, 18d that extend in the width direction of the battery pack 10, and a beam 18e that extends in the longitudinal direction of the battery pack 10. The beams 18a, 18b, 18c, 18d are arranged spaced apart in the longitudinal direction of the upper surface 14a of the bottom wall 14. The beam 18a is located at a first end in the longitudinal direction of the bottom wall 14, and the beam 18d is located at a second end in the longitudinal direction of the bottom wall 14. The beams 18b, 18c are located between the beams 18a, 18d. The beams 18a, 18b, 18c have approximately the same dimension in the width direction of the battery pack 10 (i.e., the X-direction). The dimension of the beam 18d in the width direction of the battery pack 10 is larger than the dimensions of the beams 18a, 18b, 18c in the width direction of the battery pack 10. The beam 18e is located at a second end in the width direction of the bottom wall 14. The beam 18e extends from the first end in the longitudinal direction of the bottom wall 14, across the beams 18a, 18b, 18c, to the beam 18d.

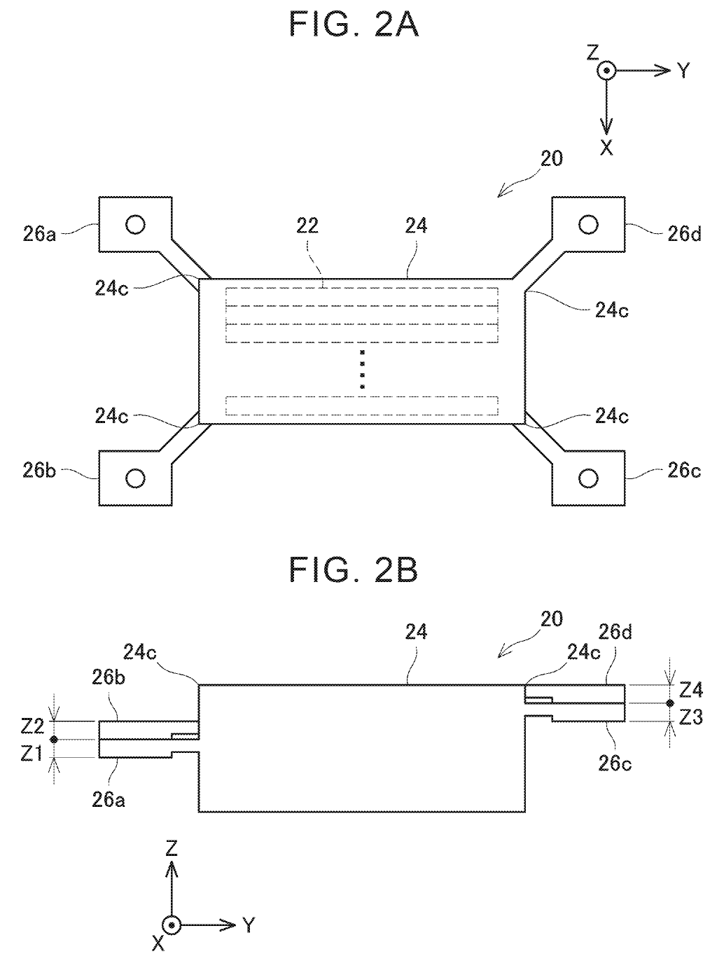

As shown in FIGS. 2A and 2B, each battery module 20 includes a plurality of battery cells 22, a module casing 24, and four fixing portions 26a to 26d. Each battery cell 22 is a rechargeable secondary battery cell. The secondary battery cell is, for example, a lithium-ion battery cell. Each battery cell 22 has a flat shape. Each battery cell 22 is, for example, a pouch battery cell (also referred to as a laminate battery cell). The battery cells 22 are stacked in the thickness direction of the battery cells 22 (i.e., the width direction of the battery pack 10). The module casing 24 houses the battery cells 22.T The module casing 24 is formed from, for example, resin. The module casing 24 has a generally rectangular-parallelepiped shape. Although not shown in the figures, the module casing 24 is open downward. End faces of the battery cells 22 are exposed through the opening of the module casing 24.

Each module casing 24 has a rectangular shape with four corners 24c as viewed in plan. Four fixing portions 26a to 26d, namely, a first fixing portion 26a, a second fixing portion 26b, a third fixing portion 26c, and a fourth fixing portion 26d, are provided at the four corners 24c, respectively. The four fixing portions 26a to 26d are provided to fix the corresponding battery module 20 to the casing 12. Each of the four fixing portions 26a to 26d has a fastening hole extending therethrough in the thickness direction (i.e., the up-down direction). The first fixing portion 26a, the second fixing portion 26b, the third fixing portion 26c, and the fourth fixing portion 26d are located at different height positions in the up-down direction (Z-direction) of the battery module 20.

As one example, as shown in FIG. 2B, the height position of the first fixing portion 26a is lower than the height position of the second fixing portion 26b. The height position of the second fixing portion 26b is lower than the height position of the third fixing portion 26c. The height position of the third fixing portion 26c is lower than the height position of the fourth fixing portion 26d. More specifically, the first fixing portion 26a is located in a first range Z1 in the up-down direction (Z-direction), and the second fixing portion 26b is located in a second range Z2 adjacent to the first range Z1 in the up-down direction. The third fixing portion 26c is located in a third range Z3 adjacent to the second range Z2 in the up-down direction, and the fourth fixing portion 26d is located in a fourth range Z4 adjacent to the third range Z3 in the up-down direction. The first range Z1, the second range Z2, the third range Z3, and the fourth range Z4 do not overlap each other. As one example, the four fixing portions 26a to 26d have substantially the same thickness dimension (i.e., the same dimension in the up-down direction). That is, Z1 = Z2 = Z3 = Z4.

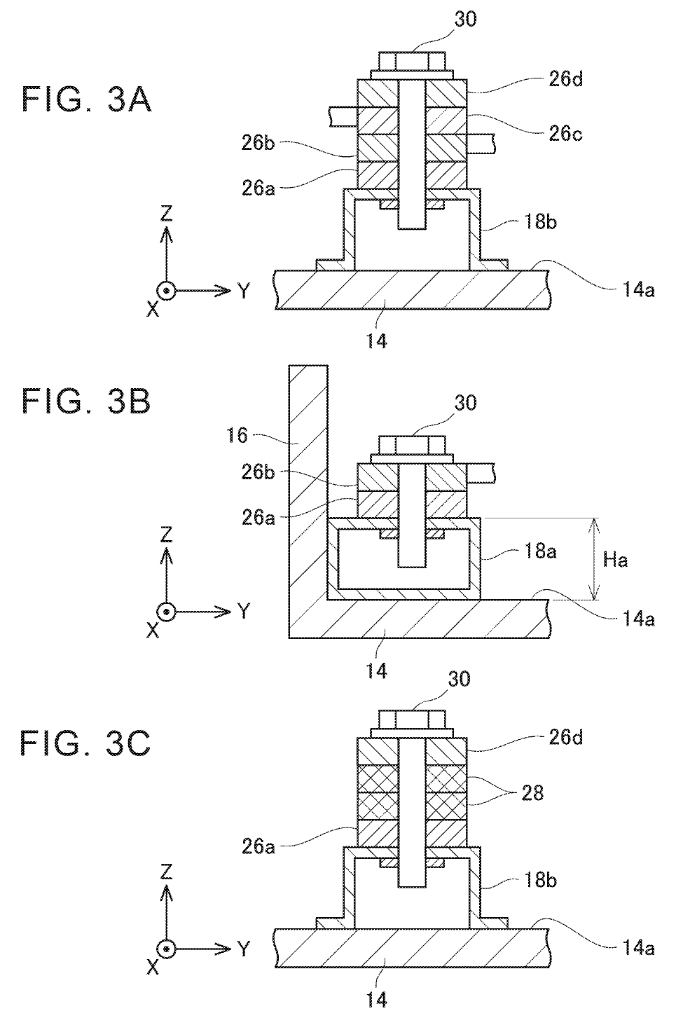

As shown in FIGS. 1 and 3A, among the battery modules 20, the first fixing portion 26a, the second fixing portion 26b, the third fixing portion 26c, and the fourth fixing portion 26d of four battery modules 20 whose corners 24c (shown in FIG. 2A) are located adjacent to each other are stacked on one another, and are fastened together to the casing 12 by the bolt 30. For example, the following description focuses on the four battery modules 20 located at the upper left portion of the figure among the battery modules 20 shown in FIG. 1. The first fixing portion 26a of the battery module 20 in the second row and second column is located on the beam 18b of the casing 12, and the second fixing portion 26b of the battery module 20 in the first row and second column is located on this first fixing portion 26a. The third fixing portion 26c of the battery module 20 in the first row and first column is located on this second fixing portion 26b, and the fourth fixing portion 26d of the battery module 20 in the second row and first column is located on this third fixing portion 26c. The bolt 30 passes through the four fastening portions 26a to 26d, stacked on one another on the beam 18b, from above and is fastened to the beam 18b.

As described above, in the present embodiment, among the fixing portions 26a, 26b, 26c, 26d of the battery modules 20, four fixing portions 26a, 26b, 26c, 26d stacked on one another are fastened together to the casing 12 by the common bolt 30. This configuration makes it possible to reduce the number of bolts 30 used for fastening the battery modules 20 to the casing 12. As a result, the number of operations for fastening the bolts 30 is also reduced, thereby simplifying the assembly process of the battery pack 10. The width direction and the longitudinal direction of the battery pack 10 are examples of the "first direction" and the "second direction," and the downward direction in the up-down direction is an example of the "third direction."

At an outer peripheral edge 21 of the battery modules 20, not all of the first fixing portion 26a, the second fixing portion 26b, the third fixing portion 26c, and the fourth fixing portion 26d are stacked on one another. The outer peripheral edge 21 is indicated by a long dashed short dashed line in FIG. 1. When the battery pack 10 is viewed in plan, the outer peripheral edge 21 of the battery modules 20 has a substantially rectangular shape and has a first side 21a, a second side 21b, a third side 21c, and a fourth side 21d. The first side 21a and the third side 21c are located on the opposite sides in the longitudinal direction of the battery pack 10. The first side 21a is located at a first end in the longitudinal direction of the outer peripheral edge 21, and the third side 21c is located at a second end in the longitudinal direction of the outer peripheral edge 21. The second side 21b and the fourth side 21d are located between the first side 21a and the third side 21c. The second side 21b and the fourth side 21d are located on the opposite sides in the width direction of the battery pack 10. The fourth side 21d is located at a first end in the width direction of the outer peripheral edge 21, and the second side 21b is located at a second end in the width direction of the outer peripheral edge 21. Hereinafter, fixing of the battery modules 20 to the casing 12 at the outer peripheral edge 21 will be described with reference to FIGS. 1, 3A, 3B, 3C, 4A, and 4B.

As shown in FIGS. 1 and 3B, at the first side 21a of the outer peripheral edge 21 of the battery modules 20, the first fixing portion 26a of one battery module 20 and the second fixing portion 26b of another battery module 20 may be stacked on one another and fastened together to the beam 18a of the casing 12 by the common bolt 30. With such a configuration, the assembly process of the battery pack 10 is further simplified. The first side 21a is an example of "one side of the outer peripheral edge" according to the present technology.

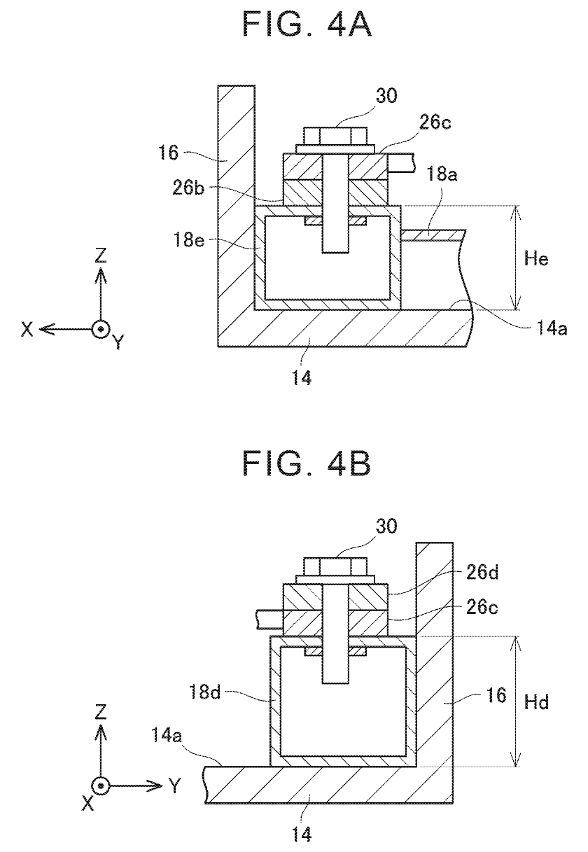

Similarly to the first side 21a, as shown in FIGS. 1 and 4A, at the second side 21b of the outer peripheral edge 21 of the battery modules 20, the second fixing portion 26b of one battery module 20 and the third fixing portion 26c of another battery module 20 are stacked on top of each other and fastened together to the beam 18e of the casing 12 by the common bolt 30. A first height position Ha of the beam 18a of the casing 12 is different from a second height position He of the beam 18e of the casing 12. Specifically, the second height position He is higher than the first height position Ha. With such a configuration, even at the outer peripheral edge 21 where not all of the four fastening portions 26a to 26d are stacked on one another, the battery modules 20 can be stably fixed to the casing 12. The first side 21a is an example of "one side of the outer peripheral edge" according to the present technology, and the second side 21b is an example of "another side of the outer peripheral edge" according to the present technology. The beam 18a is an example of the "first region" according to the present technology, and the beam 18e is an example of the "second region" according to the present technology.

As shown in FIGS. 1 and 4B, at the third side 21c of the outer peripheral edge 21 of the battery modules 20, the third fixing portion 26c of one battery module 20 and the fourth fixing portion 26d of another battery module 20 are stacked on one another and fastened together to the beam 18d of the casing 12 by the common bolt 30. The second height position He of the beam 18e of the casing 12 is different from a third height position Hd of the beam 18d of the casing 12. Specifically, the third height position Hd is higher than the second height position He. Accordingly, the relationship between the second side 21b and the third side 21c can also provide the same effects as the relationship between the first side 21a and the second side 21b described above.

As shown in FIGS. 1 and 3B, at the fourth side 21d of the outer peripheral edge 21 of the battery modules 20, the first fixing portion 26a of one battery module 20 and the fourth fixing portion 26d of another battery module 20 are stacked on one another via two spacers 28 interposed therebetween, and are fastened together to the beam 18e of the casing 12 by the common bolt 30. With such a configuration, providing the spacer(s) 28 allows the battery modules 20 to be stably fixed to the casing 12 even at the outer peripheral edge 21 where not all of the four fastening portions 26a to 26d are stacked on one another. As one example, the spacer 28 has the same shape as the region in which the fastening portions 26a, 26d are stacked on one another in the thickness direction. The spacer 28 also has substantially the same thickness dimension as each of the four fastening portions 26a to 26d. The spacer 28 has a fastening hole extending therethrough in the up-down direction. In this case, by adjusting the number of spacers 28 interposed between the fixing portions and between the fixing portions and the casing 12 for gaps of different dimensions, the battery modules 20 can be stably fixed to the casing 12.

In a modification, the number of spacers interposed between the first fixing portion 26a and the fourth fixing portion 26d at the fourth side 21d is not limited to two, and may be one. In this case, the thickness dimension of the spacer may be larger than the thickness dimension of each of the fastening portions 26a to 26d. In another modification, the battery pack 10 may not include the spacers 28. In this case, one side in the width direction of the peripheral wall 16 of the casing 12 may have a protruding portion extending toward the other side in the width direction (X-direction) of the peripheral wall 16 of the casing 12. The protruding portion may be interposed between the first fixing portion 26a and the fourth fixing portion 26d at the fourth side 21d. That is, in this case, the protruding portion may be an example of the "spacer" according to the present technology.

In the present embodiment, the height position of the first fixing portion 26a is lower than the height position of the second fixing portion 26b, the height position of the second fixing portion 26b is lower than the height position of the third fixing portion 26c, and the height position of the third fixing portion 26c is lower than the height position of the fourth fixing portion 26d. With such a configuration, the configuration of the present technology can be actively adopted.

The specific configurations of the first fixing portion 26a, the second fixing portion 26b, the third fixing portion 26c, and the fourth fixing portion 26d are not particularly limited to the configurations illustrated in the embodiment. The first fixing portion 26a, the second fixing portion 26b, the third fixing portion 26c, and the fourth fixing portion 26d may not be arranged sequentially in an anticlockwise direction, and may instead be arranged in a clockwise direction. Alternatively, when the battery module 20 is viewed in plan, the first fixing portion 26a and the second fixing portion 26b may be respectively provided at two diagonal corners 24c among the four corners 24c.

The casing 12 of the battery pack 10 may not include the beams 18a, 18b, 18c. In this case, the first fixing portion 26a, the second fixing portion 26b, the third fixing portion 26c, and the fourth fixing portion 26d that are stacked on one another may be fastened together to the bottom wall 14 of the casing 12 by the bolt 30.

What is claimed is:

1. A battery pack comprising:
a plurality of battery modules;
a casing that houses the battery modules; and
a plurality of bolts that fixes the battery modules to the casing, wherein:
the battery modules are arranged in a matrix along a first direction and a second direction;
each of the battery modules has a rectangular shape having four corners, as viewed in plan along a third direction perpendicular to the first direction and the second direction;
a first fixing portion, a second fixing portion, a third fixing portion, and a fourth fixing portion that are located at different heights are provided at the four corners, respectively; and
in four battery modules with the corners located adjacent to each other among the battery modules, the first, second, third, and fourth fixing portions are stacked on one another and are fastened together to the casing by a common bolt.

2. The battery pack according to claim 1, wherein, at one side of an outer peripheral edge of the battery modules, one of the first, second, third, and fourth fixing portions of one battery module and one of the first, second, third, and fourth fixing portions of another battery module are stacked on one another and are fastened together to the casing by a common bolt.

3. The battery pack according to claim 1, wherein, at one side of an outer peripheral edge of the battery modules, one of the first, second, third, and fourth fixing portions of one battery module and one of the first, second, third, and fourth fixing portions of another battery module are stacked on one another via a spacer and are fastened together to the casing by a common bolt.

4. The battery pack according to claim 1, wherein:
at one side of an outer peripheral edge of the battery modules, the first fixing portion of one battery module and one of the second, third, and fourth fixing portions of another battery module are stacked on one another and are fastened together to a first region of the casing by a common bolt;
at another side of the outer peripheral edge of the battery modules, either the second fixing portion or the third fixing portion of one battery module and either the third fixing portion or the fourth fixing portion of another battery module are stacked on one another and are fastened together to a second region of the casing by a common bolt; and
a height position of the first region of the casing is different from a height position of the second region of the casing.

5. The battery pack according to claim 1, wherein:
a height position of the first fixing portion is lower than a height position of the second fixing portion;
the height position of the second fixing portion is lower than a height position of the third fixing portion; and
the height position of the third fixing portion is lower than a height position of the fourth fixing portion.
